(19) United States
(12) Patent Application Publication
(10) Pub. No.: US 2024/0151385 A1
(43) Pub. Date: May 9, 2024

(54) COOKING APPLIANCE LIGHT

(71) Applicant: BJB GmbH & Co. KG, Arnsberg (DE)

(72) Inventors: Philipp Henrici, Arnsberg (DE); Olaf Baumeister, Sundern (DE); Frank Welslau, Arnsberg (DE)

(21) Appl. No.: 18/376,017

(22) Filed: Oct. 3, 2023

(30) Foreign Application Priority Data
Nov. 9, 2022 (DE) DE102022129583.4

(51) Int. Cl. F21V 3/04; F21V 33/00; H05B 6/64

(52) U.S. Cl. CPC F21V 3/04; F21V 33/0044; H05B 6/6444

(57) ABSTRACT

A cooking appliance light for a combination cooking appliance with a microwave cooking function, the cooking appliance light comprising:
a mounting sleeve configured to fix the cooking appliance light in a recess of a cooking appliance wall;
a LED illuminant arranged at the mounting sleeve wherein light from the LED illuminant is feedable through a cylindrical cavity of the mounting sleeve into a cooking cavity of the cooking appliance;
a microwave trap configured as a grid shaped blocking element configured to prevent a passage of microwave radiation from the cooking cavity through the cylindrical cavity of the mounting sleeve into an ambient of the cooking appliance; and
a translucent cover arranged at an axial end of the mounting sleeve and configured to prevent an entry of cooking vapors into the cylindrical cavity of the mounting sleeve.

### RELATED APPLICATIONS

This application claims priority from and incorporates by reference German Patent Application DE 10 2022 129 583.4 filed on Nov. 9, 2022.

### FIELD OF THE INVENTION

The invention relates to a cooking appliance light for cooking appliances with a microwave cooking function, in particular for so called combination appliances.

### BACKGROUND OF THE INVENTION

Combination cooking appliances with a microwave cooking function facilitate preparing food products by other means besides using microwaves, for example by baking or steam cooking. Combination appliances are typically provided as combined oven microwave cooking appliances or as combination appliances which also have a steam cooking function in addition to the oven function and the microwave cooking function. Additionally ovens are known in the art which increase humidity in the cooking cavity by adding small amounts of water vapor in order to support particular baking and cooking functions.

It is a particular challenge in devices with microwave cooking function to reliably prevent an exit of microwave radiation from the cooking cavity. Since cooking appliance lights require an opening in the cooking appliance wall to function, so that light is feedable through the opening into the cooking cavity, particular care has to be taken to provide this opening of the cooking appliance wall microwave tight.

It is known from U.S. Pat. No. 4,559,585 A to arrange a sleeve element behind the opening in the cooking cavity wall wherein an incandescent bulb is arranged within the sleeve element. Thus, the diameter of the sleeve element is sized so that an entry of microwaves into the sleeve element is possible, but an exit at the end oriented away from the cooking cavity is reliably prevented. However, a microwave trap configured as a grid shaped blocking element is omitted.

U.S. Pat. No. 4,367,488 discloses a grid shaped microwave trap configured as a blocking element in front of an illumination device of a microwave cooking appliance.

Conventional illuminants like gas discharge lamps but also incandescent bulbs are increasingly displaced in cooking appliances by LED illuminants. LED illuminants have an essential advantage in that they draw much less power and thus have a positive effect of reducing a total energy consumption of the cooking appliance. Additionally the LED's require little installation space so that installation space required for illumination can be reduced. Overall LED illuminants provide new design options for cooking appliances.

A smaller form factor of LED illuminants facilitates significantly reducing a size of wall cut outs in the cooking cavity wall used for introducing light that illuminates the cooking cavity which also helps to prevent thermal losses and thus reduce the energy requirement of the cooking appliance. Since energy efficiency of cooking appliances is an essential marketing element these factors are relevant for economic success.

However, significant investments are required when parts of cooking appliances have to be redesigned for using LED illuminants. This applies in particular to the cooking appliance walls which are fabricated from sheet metal plates by presses so that the wall openings e.g. for the cooking cavity illumination are produced during the forming process. Manufacturers typically require new forming tools when using LED illuminants which requires considerable investment.

### BRIEF SUMMARY OF THE INVENTION

Thus, it is an object of the invention to provide a cooking appliance light for cooking appliances with microwave cooking function that is insertable into wall cut outs for conventional illuminants and still satisfies the requirements of LED illuminants.

The object is achieved by a cooking appliance light for a combination cooking appliance with a microwave cooking function, the cooking appliance light comprising: a mounting sleeve configured to fix the cooking appliance light in a recess of a cooking appliance wall; a LED illuminant arranged at the mounting sleeve wherein light from the LED illuminant is feedable through a cylindrical cavity of the mounting sleeve into a cooking cavity of the cooking appliance; a microwave trap configured as a grid shaped blocking element configured to prevent a passage of microwave radiation from the cooking cavity through the cylindrical cavity of the mounting sleeve into an ambient of the cooking appliance; and a translucent cover arranged at an axial end of the mounting sleeve and configured to prevent an entry of cooking vapors into the cylindrical cavity of the mounting sleeve.

Using a mounting sleeve that is insertable into an existing cut out of the cooking cavity wall helps to use all advantages of modern proven assembly methods. In particular the mounting sleeve can have a closed sleeve wall and a mounting flange at an axial end proximal to the cover. The closed sleeve wall has the advantage of reliably deflecting impinging microwave radiation. Since the sleeve wall in closed, thus without cut out, no microwave radiation can exit the mounting sleeve in a radial direction.

The mounting flange is provided for threaded connection at the cooking cavity wall and includes pass through bore holes for threaded bolts. The attachment is configured electrically conductive so that an electrical connection between the mounting flange and the cooking cavity wall is provided in particular by the threaded bolts. Thus, the pass-through bore holes in the mounting flange are provided uninsulated at least in sections. Additionally at least the threads at the cooking cavity wall are provided insulated so that the threaded bolts establish the electrical connection between the mounting flange and the cooking cavity wall.

Alternatively, the mounting sleeve can be provided with interlocking lugs protruding from its circumferential wall and configured to interlock at the cooking cavity wall. This way the cooking appliance light can be fixed at the cooking cavity wall by simple insertion into the cut out of the cooking cavity wall.

Using an LED light source that is arranged at the mounting sleeve combines advantages of the mounting sleeve with a modern illuminant, in particular when the LED light source is arranged on a support element, the support element is arranged at an axial end of the mounting sleeve oriented away from the cover and the LED light source is arranged in front in light infeed direction.

The selected arrangement of the LED light source at an axial end of the mounting sleeve oriented away from the cover, in particular when the LED light source is arranged in front of the mounting sleeve in the light in feed direction, causes the LED light source to be arranged outside of the mounting sleeve. This way the LED light source is offset sufficiently far and sufficiently safe from the cooking cavity, and thus exposed to the cooking temperatures to a technically permissible extent. This provides long service life for the LED light source. Additionally it allows to run a cooling air flow past the LED so that ventilating the sleeve can be omitted. This sleeve ventilation that would be required for a LED arranged within the sleeve can only be provided with considerable complexity since required ventilation openings would have to be closed in a suitable manner in order to prevent an exit of microwave radiation.

Therefore, the blocking element is arranged within the mounting sleeve and connected with the mounting sleeve in an electrically conductive manner so that microwave radiation impinging the blocking element is absorbed by the electrical connection with the mounting sleeve and the cooking cavity wall.

Furthermore, the mounting sleeve provides an assembly stop for the blocking element and the support element supports the blocking element at the assembly stop.

This embodiment has significant fabrication advantages since the blocking element is clamped between the retaining element of the LED illuminant and the assembly stop and does not have to be attached separately.

In order to provide a positionally correct arrangement of the blocking element within the mounting sleeve, the blocking element advantageously includes centering devices which arrange and center the blocking element within the mounting sleeve.

The centering of the blocking element assures that the unavoidable fabrication tolerances and the fit clearance required for inserting the blocking element into the mounting sleeve do not lead to gap dimensions between the blocking element and the mounting sleeve which prevent an absorption of microwave radiation by the blocking element and the mounting sleeve.

Thus, the centering devices advantageously provide an electrically conductive connection between the blocking element and the mounting sleeve.

In particular, the centering device is provided as centering springs arranged at an outer circumference of the blocking element and integrally provided or bonded at the blocking element.

Another assembly advantage can be implemented when the blocking element is interlocked on the support element of the LED illuminant.

This way the blocking element forms a preassembled unit together with the support element of the LED light source wherein the preassembled unit is easily insertable into the mounting sleeve or easily applicable to the mounting sleeve.

A reliable electrically conductive connection between the mounting sleeve and the cooking cavity wall is provided when the mounting sleeve includes a plug-in connection configured to connect an electrical conductor for an electrical connection with a cooking cavity wall.

Furthermore, the mounting sleeve forms thread sections engaged by threads of the cover in order to provide disengageable fixing. This way the cover can be fixed at the mounting sleeve in a simple manner.

In particular when the interlocking assembly of the sleeve at the cooking cavity wall recited supra is preferred, the invention has the problem that the interlocking lugs projecting from the circumferential wall cause openings in the circumferential wall of the mounting sleeve. Such circumferential wall openings bear the risk that microwave radiation exits instead of being correctly absorbed.

Therefore, the mounting sleeve according to the invention is provided with an inner sleeve which covers the openings of the circumferential wall of the mounting sleeve that are caused by spreading the interlocking lugs.

The additional complexity during preassembly of the cooking cavity light is more than compensated by the simple interlocking assembly when producing the appliances so that the increased complexity during preassembly pays off very well.

A simple mounting of the inner sleeve in the mounting sleeve is assured when the inner sleeve in turn includes interlocking lobes protruding and bent outward from the inner sleeve circumferential wall that interlock the inner sleeve in the mounting sleeve.

In order to assure correct absorption of the microwave radiation it is provided that the interlocking lugs have a free interlocking end that is oriented in a direction towards the translucent cover and a connection end that is oriented away from the cover wherein the interlocking lugs are held by the interlocking end at the inner sleeve circumferential wall.

Furthermore the absorption of the microwave radiation is assured when the inner sleeve interlocks in the outer sleeve so that the interlocking lugs of the inner sleeve and the interlocking lugs of the outer sleeve are circumferentially offset from each other in order to prevent an alignment of circumferential wall cut outs of the inner sleeve and the mounting sleeve.

From a fabrication point of view it is very advantageous when the assembly stop is formed by a sleeve end of the inner sleeve that is proximal to the LED illuminant. This way the forming fabrication of the mounting sleeve for fabricating an assembly stop to support the blocking element between the LED support element and the assembly stop can be omitted.

Furthermore the centering springs reach around the inner sleeve circumferential wall.

When care is taken that the diameter of the blocking element corresponds to the diameter of the inner sleeve or exceeds the diameter of the inner sleeve a gap free arrangement of the blocking element at the inner sleeve can be provided.

Furthermore the inner sleeve forms a support flange at an end of the inner sleeve that is proximal to the translucent cover wherein the support flange contacts or envelops the assembly flange. This assures that no open annular gap is provided between the mounting sleeve and the inner sleeve, wherein microwave radiation could propagate outward through the annular gap.

An electrical connection between the blocking element and the cooking cavity wall can also be provided when the mounting sleeve provides an assembly stop for the blocking element and the support element retains the blocking element at the mounting stop.

### BRIEF DESCRIPTION OF THE DRAWINGS

Further advantages of the invention and a better comprehension thereof can be derived from the subsequent description of an advantageous embodiment with reference to drawing figures, wherein:

FIG. 1A illustrates an exploded view of a first embodiment of a cooking appliance light according to the invention;

FIG. 1B illustrates a perspective overall view of the cooking appliance light according to FIG. 1;

FIG. 2 illustrates a top view of the cooking appliance light according to FIG. 1 without cover glass;

FIG. 3 illustrates the cooking appliance light according to FIG. 1 in a first side view;

FIG. 4 illustrates a sectional view of the cooking appliance light according to sectional line IV-IV in FIG. 3;

FIG. 5 illustrates the cooking appliance light according to FIG. 1 in a second side view;

FIG. 6 illustrates a sectional view of the cooking appliance light according to the sectional line VI-VI in FIG. 5;

FIG. 7 illustrates an exploded view of a second embodiment of a cooking appliance light according to the invention;

FIG. 8 illustrates the cooking appliance light according to FIG. 7 in a perspective view;

FIG. 9 illustrates a top view of the cooking appliance light according to FIG. 7 without cover glass;

FIG. 10 illustrates a first side view of the cooking appliance light according to FIG. 7;

FIG. 11 illustrates a sectional view of a cooking appliance light according to the sectional line XI-XI in FIG. 10;

FIG. 12 illustrates a second side view of a cooking appliance light according to FIG. 7; and

FIG. 13 illustrates a sectional view according to the sectional line XIII-XIII in FIG. 12.

### DETAILED DESCRIPTION OF THE INVENTION

Two embodiments of the invention are now described based on two cooking appliance lights. For easier comprehension different number groups are used for different embodiments. Components of the first embodiment are designated with reference numerals from the number group 100-199. Components of the second embodiment are designated with reference numerals from the number group 200-299. Thus, identical of like components in the 10—number group are designated with identical numerals and are designated identically unless stated differently. Unless stated differently descriptions provided for one embodiment also apply to the other embodiment.

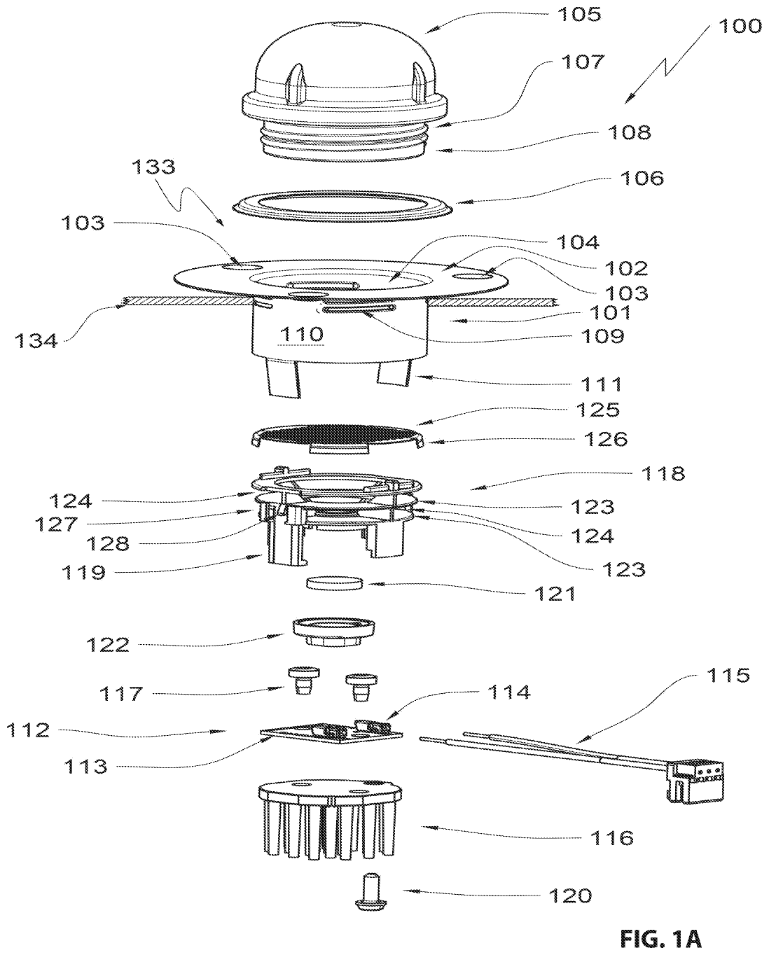

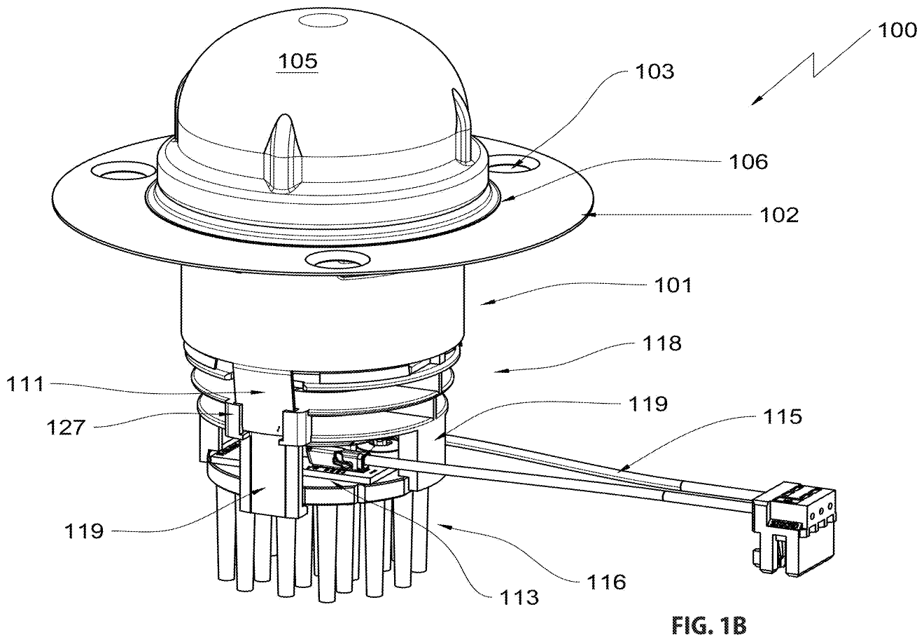

The first embodiment is illustrated in FIGS. 1-6. This is a cooking appliance light designated overall with reference numeral 100 to be used in a microwave cooking appliance in particular in a combination cooking appliance with microwave cooking function.

The exploded view according to FIG. 1A, shows the individual components of the cooking appliance light 100.

A mounting sleeve 101 is a central component of the cooking appliance light 100. The mounting sleeve 101 includes a mounting flange 102 that includes pass through bore holes 103.

The mounting sleeve 101 anchors the cooking appliance light 100 in a cut out of a cooking cavity wall. Thus, the mounting flange 102 contacts an inside of the cooking cavity wall. The pass-through bore holes 103 are aligned with threaded bore holes and possibly with threaded domes at the cooking cavity wall. Threaded bolts reach through the pass-through bore hole 103 into threads at the cooking cavity wall and support the mounting sleeve 101 which supports the entire cooking appliance light 100 at the cooking appliance wall.

The sleeve interior 104 of the mounting sleeve 101 is closed by a cover glass 105 at the cooking cavity wall. An annular element 106 is arranged between the mounting flange 102 and the cover glass 105. The annular element 106 has a sealing effect and can additionally apply a preload along a longitudinal axis of the sleeve so that the cover glass 105 threaded into the mounting sleeve 101 is fixed against unintentional unthreading.

The cover glass 105 includes a threaded neck 108 provided with an external thread 107 to provide a threaded connection of the cover glass 105 in the mounting sleeve 101. The external thread 107 engages thread sections 109, that are embossed in the circumferential wall 110 of the mounting sleeve 101.

The mounting sleeve 101 forms support lobes 111 at an end oriented away from the cover glass 105 or the mounting flange 102. The support lobes 111 are oriented along the longitudinal axis and their free ends are oriented radially inward.

A LED illuminant configured as a circuit board 113, carrying a LED functions as illuminant 112 of the cooking appliance light 100 and furthermore includes terminals configured to connect with connection conductors 115. The connection conductors 115 primarily supply the LED with power but can also be used to transmit control signals.

The circuit board 113 is mounted on a reaction bearing 116 thus configured as a cooling body. The cooling body 116 dissipates waste heat generated by operating the LED. Studs 117 are provided to attach the circuit board 113 at the cooling body 116.

A support element 118 receives the cooling body 116 with the circuit board 113 arranged thereon at an end oriented away from the mounting sleeve 101 with a support arm 119. Thus, the cooling body 106 is advantageously interlocked at the support arms 119. Additionally the cooling body can be fixed at the support element 118 by a safety element 120 configured as a bolt.

The support element 118 furthermore supports an optical element 121 in the instant embodiment, e.g. a lens that is arranged in a beam path of the light emitting LED of the circuit board 113 and orients the emitted light to provide optimum light feed into the cooking cavity. The optical element 121 is arranged in a support ring 122. The support ring 122 provides correct distance between the optical element 121 and the LED. Furthermore, the support ring 122 can also function as a reflector configured to feed scatter light emitted by the LED to the optical element 121 in order to use the scatter light for cooking cavity illumination.

The support element 118 is formed by plural annular discs 123, offset from each other, along a longitudinal axis of the sleeve. These annular discs 123 form a heat shield that reduces radiation heat that propagates from the cooking cavity through the mounting sleeve 101 towards the light source 112. Furthermore the radial gaps 124 between the annual discs 123 facilitate a pass-through air flow which provides heat dissipation and thus cooling and protection for the LED light source 112.

Last not least, the cooking appliance light 100 includes a microwave trap configured as a grid shaped blocking element 125. The grid shaped blocking element is configured as an essentially circular perforated disc. Centering devices 126 configured as axially oriented spring ribs extend from edges of the disc wherein the spring ribs protrude radially by a minimum amount. The spring ribs are supported at an inner circumference of the circumferential wall when mounting the blocking element 125 in the mounting sleeve 101 and center the blocking element 125 within the mounting sleeve 101.

Last not least the support element 118 forms plug in receivers 127 that are configured to receive support lobes 111, wherein each plug-in receiver 127 includes an interlocking lug 128 that engages an interlocking opening of the support lobe 111 to provide safety.

The perspective view according to FIG. 1B shows the cooking appliance light 100 in assembled condition. It is clearly visible how the cover glass 105 is fixed at the mounting sleeve 101. Thus, the annular element 106 is arranged between the cover glass 105 and the mounting flange 102.

The support element 118 supports the cooling body 116 with its support arms 119 wherein the cooling body supports the circuit board 113 and is supported on the support element 118 on a side that is oriented away from the cover glass 105.

The support lobes 111 are inserted into the plug-in receiver 127 of the support element 118 and thus fix the support element 118 at the mounting sleeve 118.

The preassembled cooking appliance light 100 can thus be mounted in the cooking appliance at a cooking appliance manufacturer.

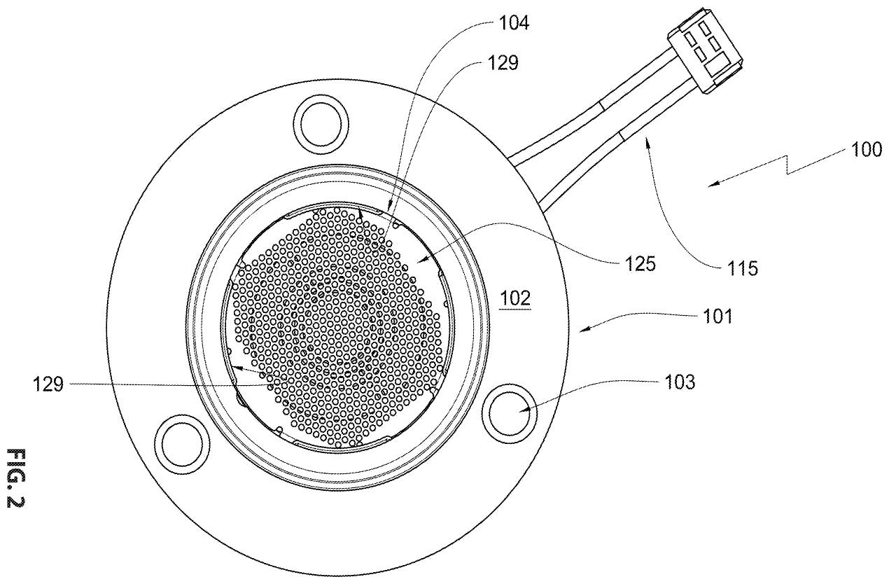

FIG. 2 shows a top view of the cooking appliance light 100 without the cover glass 105, showing the annular blocking element 125 configured as a perforated disc arranged centered in the sleeve interior 104. This also shows that the centering assures that clearance required for assembly provided in circumferential gap sections 29 is sized about the same all around. Thus, a distance provided by each of the circumferential gap sections 129 between the circumferential wall 110 of the mounting sleeve 101 and the blocking element 125 is not greater with respect to its radial depth than the diameter of the perforation holes of the blocking element 125. This assures that no microwave radiation can penetrate outward through the mounting sleeve 101 in the axial direction.

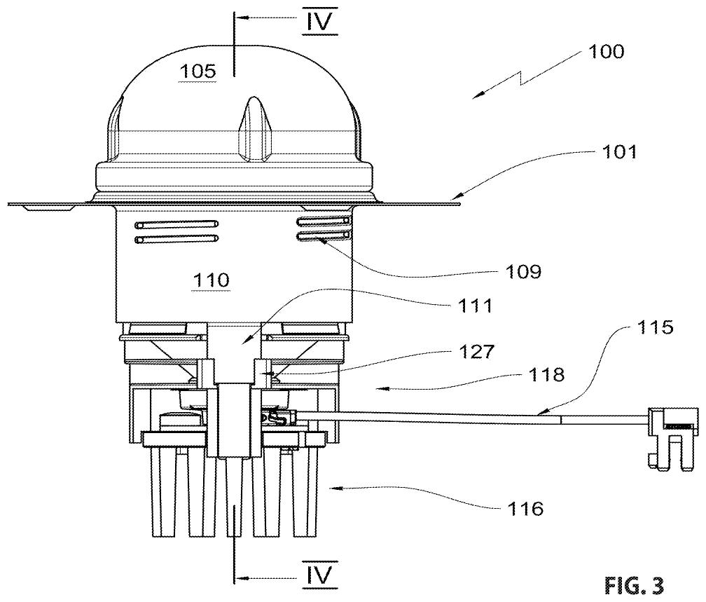

FIG. 3 shows a side view of the cooking appliance light 100 showing how the thread sections 109 are embossed in the circumferential wall 110 of the mounting sleeve 101. FIG. 3 also shows that the support lugs 111 of the mounting sleeve 101 are seated in plug in receivers 127 of the support element 118.

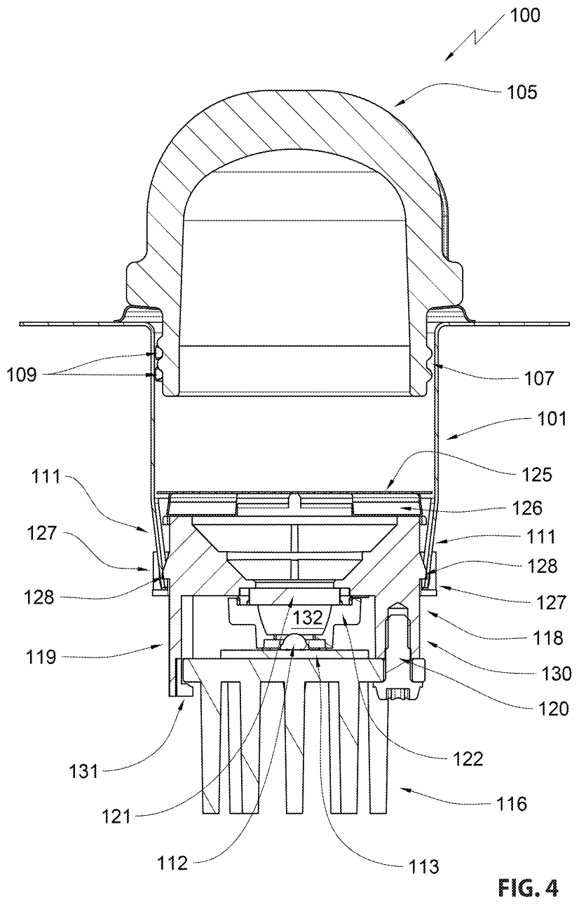

FIG. 4 shows a sectional view of the cooking appliance light 100 along the sectional line IV-IV in FIG. 3 showing a cooperation of the thread sections 109 at the mounting sleeve 101 and of the outer thread 107 of the cover glass 105. The blocking element 125 requires special attention. It is evident from this drawing figure that the blocking element 125 sits on the support element 118, wherein the centering devices 126 also support the blocking element 125 on the support element 118, advantageously by interlocking. This provides advantageous assembly. Thus, the blocking element 125 seated on the support element 118 can be fixed at the mounting sleeve 101 together with the support element 118. The support element 118 penetrates the sleeve interior 104 by a small amount with an end section of the support element 118 that is proximal to the cover glass 105. This way the blocking element 125 is introduced into the sleeve interior 104 horizontally or transversal to a longitudinal axis of the sleeve which provides a correct assembly position.

This also shows how the cooling body 106 is fixed in the support element 118 by the safety element 120. The support element 118 forms a safety protrusion 130 for this purpose which extends in opposite direction to the cover glass. This also shows how the cooling body 116 is engaged by an interlocking protrusion of the support arm 119.

FIG. 4 also shows that the interlocking lugs 128 of the plug-in receivers 127 engage the support lugs 111 of the mounting sleeve 101.

Eventually this shows how the optical element 121 is seated in the support ring 122 and how the optical element 121 arranges the optical element at a correct distance from the circuit board 113 or the illuminant 112. This illustration also shows that the support ring 122 can function as a reflector when the interior surfaces 132 are mirror coated.

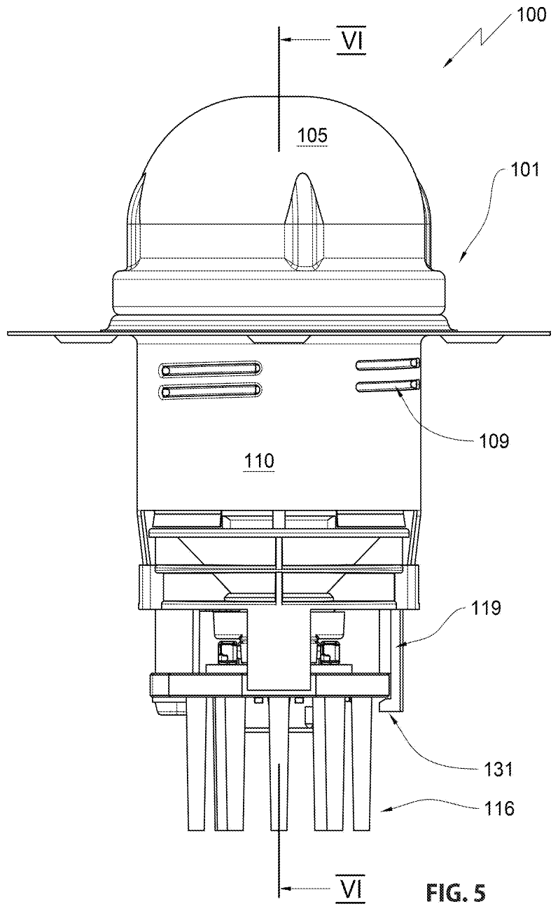

FIG. 5 shows an additional side view of the cooking appliance light 100. The side view is rotated by approximately 90 degrees compared to the representation according to FIG. 3.

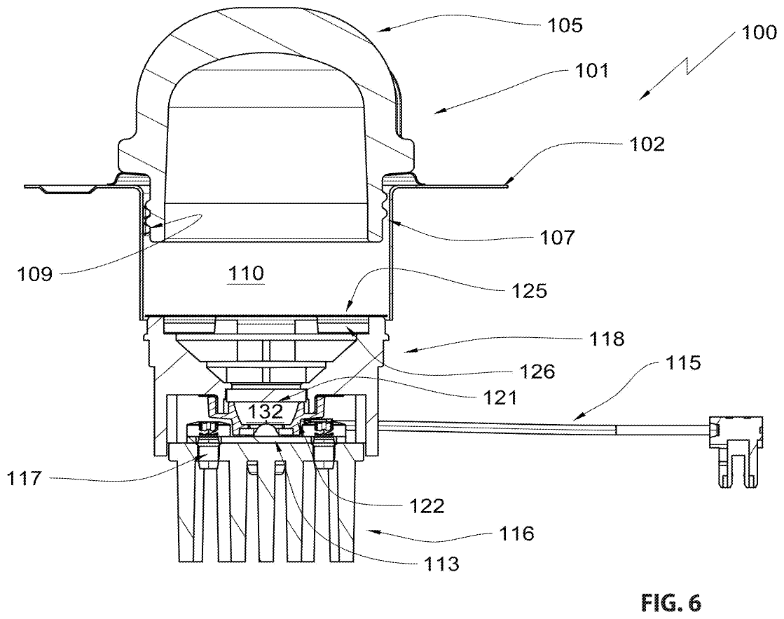

FIGS. 5 and 6 show the features described with reference to FIGS. 3 and 4 in a different perspective. In particular the attachment of the circuit board 113 at the cooling body by the studs 117 is shown in FIG. 6.

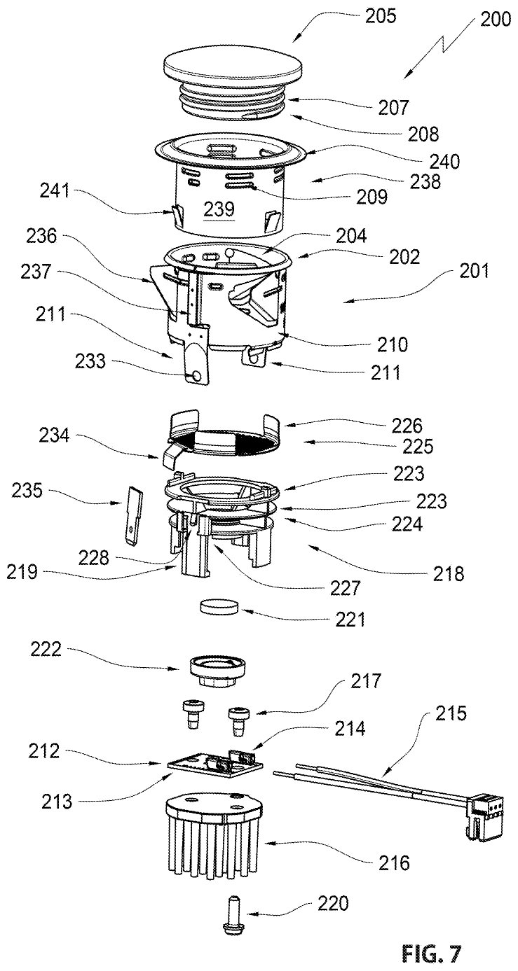

FIGS. 7-13 show a cooking appliance light 100 designated overall with reference numeral 200 as a second embodiment of the invention.

The second cooking appliance light 200 is shown in an exploded view in FIG. 7 and also includes a mounting sleeve 201 that arranges the cooking appliance light 200 in the recess of a cooking appliance wall of the cooking appliance.

The cooking appliance light 200 is similar in essential components to the cooking appliance light 100 according to the first embodiment as will be described infra.

The mounting sleeve 201 also includes a mounting flange 202 and forms a sleeve interior 204. The cover glass 205 includes a threaded neck 208 with an exterior thread 207. A circumferential wall 210 of the mounting sleeve 201 forms support lobes 211. The support lobes 211 are arranged at an end of the mounting sleeve 201 that is oriented away from the mounting flange 202 and extends from the mounting flange 202 in a longitudinal direction wherein the support lobes 211 protrude slightly radially inward.

An illuminant 212 configured as a circuit board 213 with a LED placed thereon and not designated separately is also provided in the second embodiment of the cooking appliance light 200. Also in this embodiment the circuit board 213 includes terminal clamps 214 configured to connect with connection conductors 215. The connection conductors 215 supply the illuminant 212 with electricity, but can also transmit control signals as needed.

The circuit board 213 is fixed by studs 217 on a reaction bearing 216 configured as a cooling body.

The cooling body 216 itself is arranged at an end of the support element 218 oriented away from the cover glass 205 and fixed by support arms 219 provided at this location. Thus, the support arms 219 can interlock on the cooling body 216. Also here a safety element 220 can be used for additional fixing of the cooking body 216 at the support element 218 in the second embodiment.

It is also provided in the second embodiment of the cooking appliance light 200 to arrange an optical element 221 in the beam path of light emitted by the illuminant 212 in order to orient and in particular collect the light maximizing light yield and optimizing illumination of the cooking cavity. Also here the optical element 221 is supported in s support ring 222, which simultaneously offsets the optical element 221 with a correct offset from the LED. Thus, the support ring 222 can be additionally provided as a reflector and can reflect the scatter light in a direction towards the optical element 221 and thus in a direction towards the cooking cavity.

The support element 218 includes plural annular discs 223 also in the second embodiment of the invention, wherein the annular discs are arranged with an axial offset from each other so that intermediary spaces 224 are provided between the annular discs 223. The center annular cavity of each support ring 223 facilitates radiating light emitted by the LED through the support element 218 in a direction towards the cooking cavity.

The support element 218 includes plug in receivers 227 which are also provided with an optional interlocking lug 128 in this embodiment and which are configured to receive support lobes 211. It is evident from the illustration showing the second embodiment that the support lobes 211 are provided with an interlocking opening 233 where the interlocking lugs 228 secure the support element 218 at the mounting sleeve 210.

FIG. 7 also shows a disc shaped blocking element 225 functioning as a microwave trap which is perforated for light pass through by a number of small perforations. Also in this embodiment, the blocking element 225 includes centering devices 226 which are configured as essentially axially oriented spring lobes. Differently from the first embodiment the blocking element 225 includes an attachment lobe 234 where an electrically conductive flat plug 235 is attachable. The flat plug 235 can be welded on, soldered on, or can be fixed mechanically at the attachment lug. The flat plug 235 facilitates establishing an electrical connection to an opposite plug at the cooking cavity wall through a conductor cable in order to neutralize energy impacting the blocking element 225.

There are differences in detail, in particular with respect to the mounting sleeve 201. The mounting sleeve 201 includes interlocking lugs 236 that radially protrude outward from the circumferential wall 210. When mounting the cooking appliance light 200 in a cut out of a cooking cavity wall, the cooking appliance light 200 is inserted from the cooking cavity outward into the cooking cavity wall recess. The insertion movement terminates when the mounting flange 202 contacts an inside of the cooking cavity wall. The interlocking lugs 236 slide at the cut out during the insertion process and reach behind the cooking cavity wall after moving through the cut out so that the cooking cavity wall is arranged between the interlocking lugs 236 and the mounting flange 202 so that the cooking appliance light 200 is safely retained.

A coding bar 237 formed by the circumferential wall 210 facilitates a safe and defined alignment of the cooking appliance light 200 relative to the wall cut out.

The cooking appliance light 200 according to the second embodiment of the invention includes an inner sleeve 238. The inner sleeve 238 has a smaller diameter than the mounting sleeve 201. The inner sleeve 238 includes a sleeve wall 239. Thread sections 209 are embossed into the sleeve wall 239. The thread sections 209 cooperate with the outside thread 207 of the cover glass 205, so that the cover glass 205 is threadable into the inner sleeve 238 for fixing purposes.

The inner sleeve 238 includes a contact flange 240 formed at an end proximal to the cover glass 205. The contact flange 240 covers an annular cavity 244 provided between the inner sleeve 238 and the mounting sleeve 201 so that microwave radiation is reliably prevented from entering the annular cavity 244.

The inner sleeve 238 includes an interlocking lug 241 for anchoring the inner sleeve 238 in the mounting sleeve 201. The interlocking lobes are deflected out of the sleeve wall 239. Thus, the interlocking lobes 241 are connected at the sleeve wall with an end of the interlocking lobes that is remote from the cover glass 205, whereas an end of the interlocking lobes 241 proximal to the cover glass 205 is cantilevered radially outward.

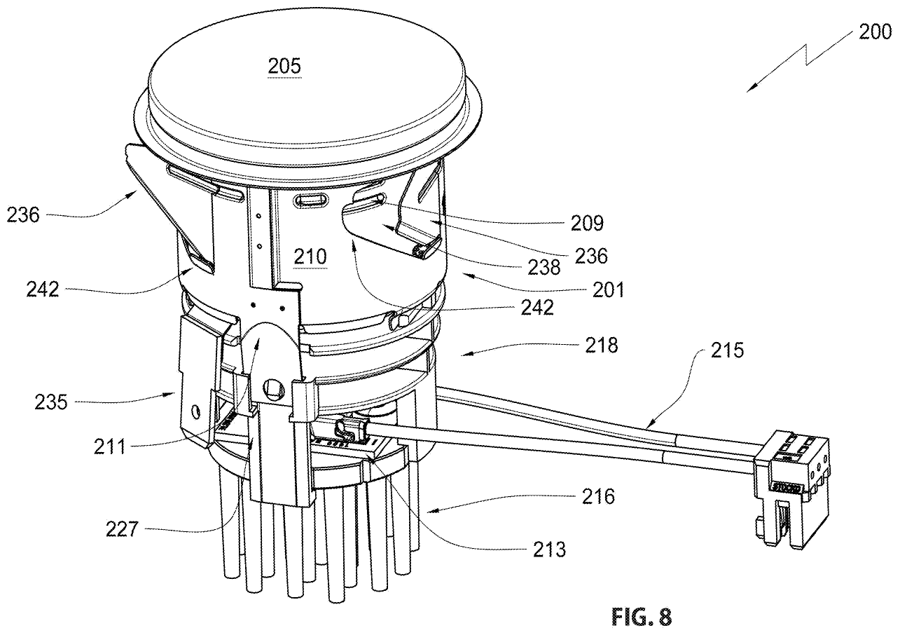

FIG. 8 shows a perspective view of the cooking appliance light 200, in an assembled form. The cover glass 205 is threaded into the inner sleeve 238 wherein the external thread 207 engages the thread sections 209 of the inner sleeve 238.

The blocking element 225 is arranged in the mounting sleeve 201 in a manner that will be described infra. The support element 218 is also connected at the mounting sleeve 201 so that the support lobes 211 engage the plug-in receivers 227 of the support element 218. Since the sub assembly including the support element 218, the illuminant 212 and the cooling body 216 are configured identical to the first embodiment as stated supra the descriptions provided supra are being referred to.

FIG. 8 shows differently from the first embodiment that the flat plug 235 which is electrically connected by the blocking element 225 in this embodiment runs out of the mounting sleeve 201 remote from the cover glass so that an electrical conductor is connectable.

FIG. 8 shows additionally how the mounting sleeve 201 and the inner sleeve 238 cooperate with respect to the interlocking lug 236. As stated supra and evident from FIG. 8, bending the interlocking lugs 236 outward from the circumferential wall 210 of the mounting sleeve 201 creates cut outs 242 in the circumferential wall 210. The inner sleeve 238 is arranged in the mounting sleeve 210 so that it covers the cut outs 242. Therefore, microwaves entering through the cover glass 205 cannot exit through the cut out 242.

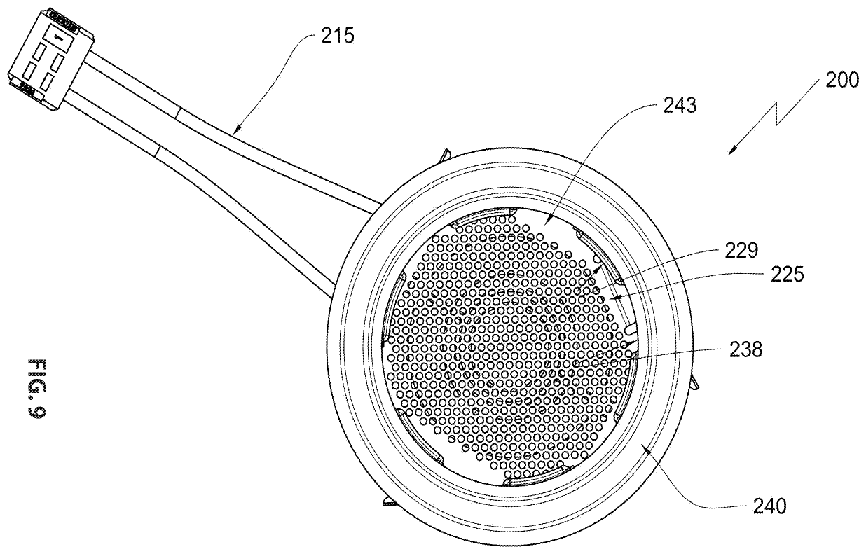

FIG. 9 of the second embodiment is analogous to the representation of FIG. 2 of the first embodiment. FIG. 9 also shows a top view of the cooking appliance light 200 wherein essentially features are shown that are identical to FIG. 2 or the first embodiment. This is a blocking element 225 configured as a disc, perforated by a plurality of holes, and arranged in the sleeve interior 243. This view shows in particular the contact flange 240 of the inner sleeve 238, wherein the contact flange 240 covers the mounting flange 202 of the mounting sleeve 201. This view additionally shows the function of the centering devices 226 which centers and fixes the blocking element 225 in the sleeve interior 243. This way the fit or mounting clearance required for mounting the blocking element and the resulting circumferential gap sections 229 are reduced to a size which is not greater than the diameter of the perforation holes. This reliably prevents that microwave radiation exits axially through the circumferential gap sections 229 from the sleeve interior 243 into the ambient.

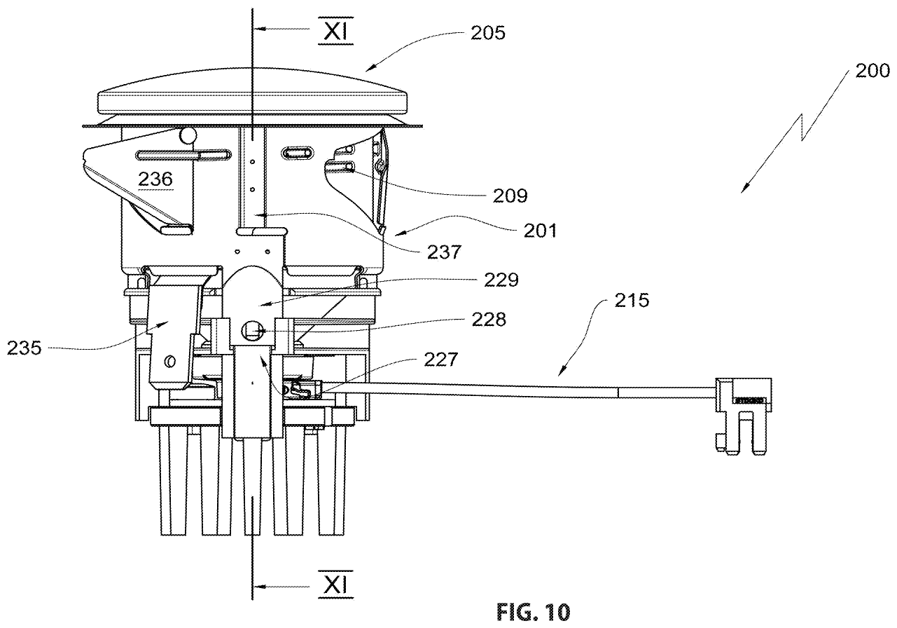

The side view of the cooking appliance light 200 of the second embodiment in FIG. 10 corresponds to FIG. 3 of the first embodiment. Additionally it is shown how the flat plug 235 is run out of the sleeve interior 204 of the mounting sleeve 201. Also, the locking effect of the interlocking lug 228 in the plug-in receiver 227 configured to fix the support arm 229 is clearly visible.

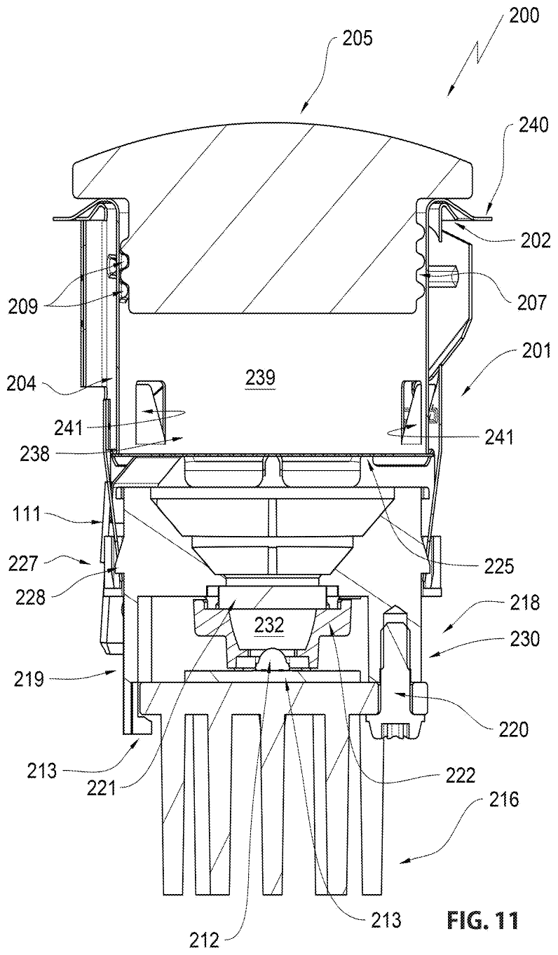

FIG. 11 shows a sectional view according to sectional line XI in FIG. 10 showing a general configuration of the cooking appliance light 200 in assembled form. This largely corresponds to FIG. 4 of the first embodiment with respect to components below the mounting sleeve 201, thus components arranged at an end of the mounting sleeve 201 that is distal from the cover glass, thus FIG. 4 is being referred to.

FIG. 11 shows in particular the interaction of the mounting sleeve 201 and the inner sleeve 238, showing that the inner sleeve 238 is arranged and concentrically supported in the sleeve interior 204 of the mounting sleeve 201. The contact flange 240 covers the mounting flange 202, and thus covers an annular cavity 244 towards the cooking cavity, wherein the annular gap is provided between the mounting sleeve 201 and the inner sleeve 238. A propagation of microwave radiation into this annular cavity 244 and thus a possible axial passage of microwave radiation into the ambient is reliably prevented.

It is not required but advantageous when the inner sleeve 238 interlocks in the mounting sleeve 201. This significantly facilitates arranging the inner sleeve 238 in the mounting sleeve 201. The interlocking lobes 241 described supra are used for this purpose.

Since the interlocking lobes 241 that are deflected from the sleeve wall 239 introduce cut outs into the sleeve wall 239, initially the particular arrangement of the interlocking lobes 241 with their connected end distal from the cover glass, and their deflected end proximal to the cover glass 205 was selected. Thus, impinging microwave radiation is reflected back towards the cooking cavity or absorbed by electrical conduction. If microwave radiation exits through the cut outs of the sleeve wall 239, it can only enter into the annular cavity 244, and is absorbed at this location when impacting the mounting sleeve 201. In order to reliably prevent a radial exit of microwave radiation from the arrangement of microwave sleeve 201 and inner sleeve 238, the cut outs of the sleeve wall 239 are offset sufficiently in any case from the cut outs of the circumferential wall 210 of the mounting sleeve 201.

FIG. 11 furthermore shows how the cover glass 205 is supported in the inner sleeve 238, in analogy to the arrangement of the cover glass 105 in the mounting sleeve 101 according to the first embodiment.

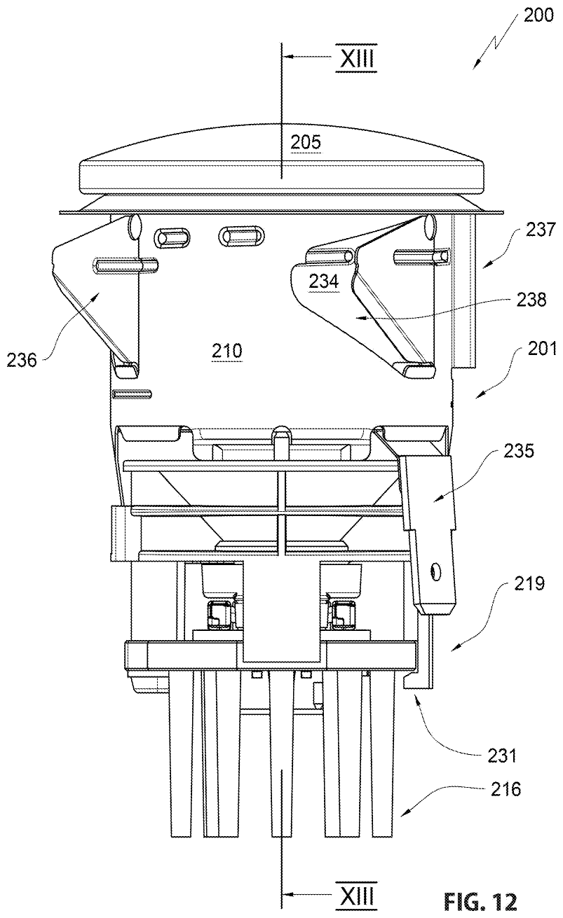

FIG. 12 shows a second side view of the cooking appliance light 200. FIG. 12 is equivalent to FIG. 5 of the first embodiment. Descriptions provided with respect to FIG. 5 analogously apply to FIG. 12. With respect to the specific components of the second embodiment reference is made to the description with respect to FIG. 10.

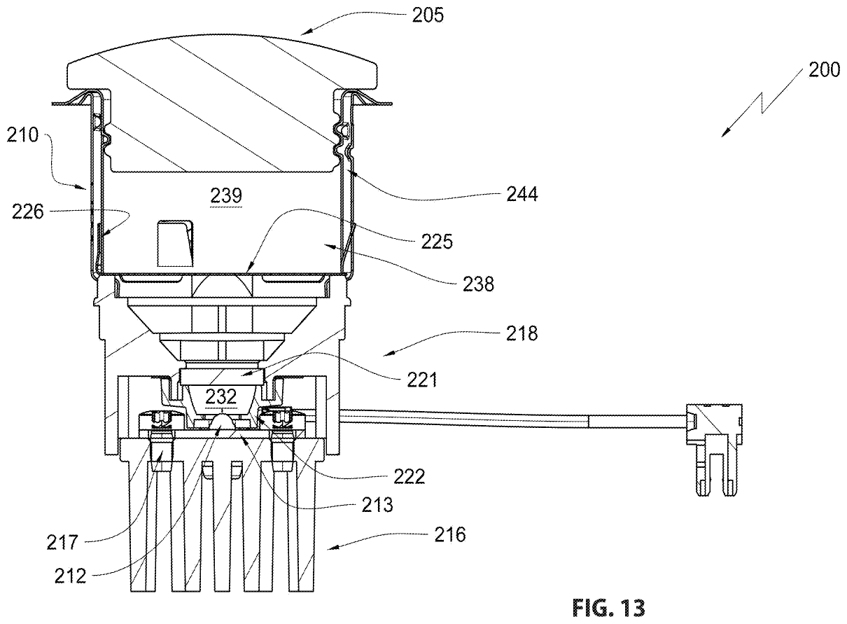

FIG. 13 shows a sectional view according to sectional line XIII in FIG. 12. FIG. 13 is analogous to FIG. 6 of the first embodiment. Descriptions provided with respect to FIG. 6 apply to all components of the cooking appliance light 200 that are not specific to the second embodiment.

The arrangement of the blocking element 225 of the cooking appliance light 200 is specific to the second embodiment, as evident from FIG. 13 in conjunction with FIG. 11. The blocking element 225 of the cooking appliance light 200 contacts the end of the inner sleeve 238 that is distal from the cover glass, wherein the inner sleeve 238 forms a mounting end stop for the blocking element 225. The blocking element 225 is supported between an end of the inner sleeve 238 that is distal to from the cover glass 205 and an end of the support element 218 that is proximal to the cover glass 205.

Differently from the first embodiment, the centering devices 226 are not supported at an inner circumference of the sleeve wall 239 or the circumferential wall 210. Instead the centering devices 226 contact an outer circumference of the sleeve wall 239 of the inner sleeve 238. The centering devices 226 support the blocking element 225 at least by friction locking, form locking is also conceivable.

It was proposed for the first embodiment of the cooking appliance light 100, to preassemble the blocking element 125 on the support element 118, thus it is proposed for the cooking appliance light 200 according to the second embodiment to perform a pre-assembly of the blocking element 225 on the inner sleeve 238. Thus, the inner sleeve 238 including the blocking element 225 is inserted into the mounting sleeve 201 in order to assemble the light. The support element 218 is applied in the opposite direction from a side distal from the cover glass 205 to an end of the mounting sleeve 201 distal from the cover glass 205 so that the blocking element 225 is reliably arranged between the support element 218 and the inner sleeve 238.

The second embodiment does not require an inner sleeve 238 when wall gaps created by deflecting the interlocking lugs 236 are kept tight enough. An exit of microwave radiation can thus be reliably prevented also without the inner sleeve 238. Fixing the support element 218 and the blocking element 225 and the cover glass 205 is then performed analogous to the first embodiment.

Two embodiments of cooking appliance light 100, 200 were introduced which have the production advantages that will be described infra.

Cooking appliance manufacturers can use the lights 100, 200 for microwave cooking appliances or combination cooking appliances having a microwave cooking function, since an effective blocking element and a well-designed light configuration reliably prevents an exit of microwave radiation from the cooking cavity. Thus, the contact flange 240 of the inner sleeve 238 helps preventing the exit of the microwave radiation. In any case a secure and centered support of the blocking element 125, 225 in the cooking appliance light 100, 200 is assured.

The cooking appliance light 100, 200 is configured to be mounted in cooking cavity wall cut outs that are configured for conventional illuminants but uses an LED illuminant 112, 212. Thus the cooking appliance lights 100, 200 adapt existing component structures to modern LED illuminants. Thus, advantageous attachment techniques are used for anchoring the cooking appliance light 100, 200 which were previously used for cooking appliance lights with conventional illuminants 112, 212.

However, both embodiments of the cooking appliance light 100, 200 also comply with the requirements of LED illuminants, in particular reliably protecting them against potentially damaging heat radiation of the cooking cavity. Thus, the LED illuminant 112, 212, is arranged outside of the mounting sleeve 201, in particular at an end of the mounting sleeve 201 that is distal from the cover glass 105, 205. This offsets the LED illuminant 112, 212 from the cooking cavity and supports the LED illuminant 112, 212 outside of the sleeve body which is subject to increased temperature. Using a support element 118, 218 facilitates supporting the illuminants 112, 212 outside the mounting sleeve 201.

For this purpose a special support element is used which facilitates advantageous ventilation through the intermediary spaces 224, 124 and a protection against thermal radiation through annular discs 123, 223 in addition to providing an advantageous embodiment of the illuminants 112, 212 outside the mounting sleeve 201.

### REFERENCE NUMERALS AND DESIGNATIONS

100 cooking appliance light
101 mounting sleeve
102 mounting flange
103 pass through bore hole
104 sleeve interior
105 cover glass
106 ring element
107 external thread
108 threaded neck
109 thread section
110 circumferential wall vs. 101
111 support lobe
112 illuminant
113 circuit board
114 connection terminal
115 connection conductor
116 reaction bearing/cooling body
117 stud
118 support element
119 support arm
120 safety element
121 optical element
122 retaining ring
123 annular disc
124 intermediary space
125 blocking element
126 centering device
127 plug-in receiver
128 interlocking lug
129 circumferential gap section
130 safety dome
131 interlocking protrusion
132 inner surface
133 cooking cavity
134 cooking appliance wall
200 cooking appliance light
201 mounting sleeve
202 mounting flange
203 pass through bore hole
204 sleeve interior
205 cover glass
206 ring element
207 external thread
208 threaded neck
209 thread section
210 circumferential wall vs. 201
211 support lobe
212 illuminant
213 circuit board
214 connection terminal
215 connection conductor
216 reaction bearing/cooling body
217 stud
218 support element
219 support arm
220 safety element
221 optical element
222 retaining ring
223 annular disc
224 intermediary space
225 blocking element
226 centering device
227 plug-in receiver
228 interlocking lug
229 circumferential gap section
230 safety dome
231 interlocking protrusion
232 inner surface
233 interlocking opening vs. 211
234 attachment lobe
235 flat plug
236 interlocking lobe vs. 201
237 coding bar
238 inner sleeve
239 sleeve wall
240 support flange
241 interlocking lobe
242 cut out
243 sleeve interior
244 annular cavity

What is claimed is:

1. A cooking appliance light for a combination cooking appliance with a microwave cooking function, the cooking appliance light comprising:
a mounting sleeve configured to fix the cooking appliance light in a recess of a cooking appliance wall;
a LED illuminant arranged at the mounting sleeve wherein light from the LED illuminant is feedable through a cylindrical cavity of the mounting sleeve into a cooking cavity of the cooking appliance;
a microwave trap configured as a grid shaped blocking element configured to prevent a passage of microwave radiation from the cooking cavity through the cylindrical cavity of the mounting sleeve into an ambient of the cooking appliance; and
a translucent cover arranged at an axial end of the mounting sleeve and configured to prevent an entry of cooking vapors into the cylindrical cavity of the mounting sleeve.

2. The cooking appliance light according to claim 1,
wherein the LED illuminant is mounted on a support element,
wherein the support element is arranged at an axial end of the mounting sleeve oriented away from the translucent cover, and
wherein the LED illuminant is arranged upstream in light feed direction from an axial end of the mounting sleeve oriented away from the translucent cover.

3. The cooking appliance light according to claim 2, wherein the grid shaped blocking element is arranged within the mounting sleeve and connected in an electrically conductive manner with the mounting sleeve.

4. The cooking appliance light according to claim 3, wherein the mounting sleeve includes a mounting stop for the grid shaped blocking element and the support element supports the grid shaped blocking element at the mounting stop.

5. The cooking appliance light according to one of the claim 1, wherein the grid shaped blocking element includes centering devices that support the grid shaped blocking element centered within the mounting sleeve.

6. The cooking appliance light according to claim 5, wherein the centering devices are configured as centering springs arranged at an outer circumference of the grid shaped blocking element and integrally configured with or bonded to the grid shaped blocking element.

7. The cooking appliance light according to one of claim 1, wherein the grid shaped blocking element is interlocked on the support element of the LED illuminant.

8. The cooking appliance light according to claim 1, wherein the mounting sleeve includes a plug-in connection configured to connect an electrical conductor that electrically connects with the cooking cavity wall.

9. The cooking appliance light according to claim 1, wherein the mounting sleeve forms thread sections that are engaged by second thread sections of the translucent cover providing disengageable fixing.

10. The cooking appliance light according to claim 1, wherein the mounting sleeve includes a closed sleeve wall and a mounting flange at an axial end of the mounting sleeve proximal to the translucent cover.

11. The cooking appliance light according to claim 10, wherein the mounting flange includes pass through bore holes for threaded bolts configured to provide an electrically conductive threaded connection with the cooking cavity wall.

12. The cooking appliance light according to claim 1, wherein the mounting sleeve includes a mounting flange and interlocking lobes bent out of a circumferential wall of the mounting sleeve and configured to interlock with the cooking cavity wall.

13. The cooking appliance light according to claim 12, wherein the mounting sleeve includes an inner sleeve which covers openings of the circumferential wall of the mounting sleeve caused by bending the interlocking lobes out.

14. The cooking appliance light according to claim 13, wherein the inner sleeve includes second interlocking lobes that are bent out of inner sleeve circumferential wall and interlock the inner sleeve in the mounting sleeve.

15. The cooking appliance light according to claim 14,
wherein the second interlocking lobes include a free interlocking end oriented towards the translucent cover and a connection end oriented away from the translucent cover, and
wherein the interlocking end retains the second interlocking lobes at the inner sleeve circumferential wall.

16. The cooking appliance light according to claim 14, wherein the second interlocking lobes of the inner sleeve and the interlocking lobes of the mounting sleeve are circumferentially offset relative to each other, which prevents an alignment of circumferential wall cut outs of the inner sleeve and the mounting sleeve.

17. The cooking appliance light according to claim 4, wherein the mounting stop is formed by a sleeve end of the inner sleeve proximal to the LED illuminant.

18. The cooking appliance light according to claim 6, wherein the centering springs reach behind the inner sleeve circumferential wall.

19. The cooking appliance light according to claim 12,
wherein the inner sleeve forms a support flange at an end proximal to the translucent cover, and
wherein the support flange contacts the mounting flange.

20. The cooking appliance light according to claim 1, wherein the blocking element includes a plug connection electrically connecting with the cooking cavity wall.
